(19) United States
(12) Patent Application Publication
(10) Pub. No.: US 2010/0007606 A1
(43) Pub. Date: Jan. 14, 2010

(54) Handheld Electronic Apparatus with Multiple Input Devices

(75) Inventor: Mark Shkolnikov, Herndon, VA (US)

Correspondence Address: LIEBERMAN & BRANDSDORFER, LLC, 802 STILL CREEK LANE, GAITHERSBURG, MD, 20878, US

(73) Assignee: KEYNETIK, INC., Herndon, VA (US)

(21) Appl. No.: 12/500,640

(22) Filed: Jul. 10, 2009

Related U.S. Application Data
(60) Provisional application No. 61/079,996, filed on Jul. 11, 2008.

(51) Int. Cl. G06F 3/033

(52) U.S. Cl. 345/161

(57) ABSTRACT

A method, apparatus, and article of manufacture are provided to support communication from two or more input devices to an image on a visual display of a handheld computing apparatus. At least two input devices are provided, together with a mapping of positions of the input devices. Each mapping of the combined input devices is configured to manipulate an image on the visual display.

### CROSS REFERENCE TO RELATED APPLICATION(S)

The present application is a non-provisional utility patent application claiming the benefit of U.S. Provisional Patent Application Ser. No. 61/079,996, filed on Jul. 11, 2009 and titled “Electronic Handhelds with Two Pointing Devices,” now pending, which is hereby incorporated by reference.

### BACKGROUND OF THE INVENTION

1. Technical Field

This invention relates to a portable electronic apparatus. More specifically, the invention relates to employment of multiple input devices and conversion of actuation of the devices into commands.

2. Description of the Prior Art

A computer is a programmable machine that responds to a specific set of instructions in a well-defined manner and executes a pre-recorded list of instructions, also known as a program. Modern computers are electronic and digital that employs hardware components to support the list of instructions. Hardware components include, but are not limited to, processors, memory, storage, input devices, output devices, etc. As noted above, programs are employed to manipulate data, send messages to an external device, etc.

Computers have evolved over time from a large stand-up computer requiring punch cards, to personal desktop computer, portable laptop computer, personal digital assistants, etc. Regardless of the form of the computer, each computer requires input in some form from an input device. Examples of an input device include a keyboard, a mouse, a trackball, a pointer, etc.

The current generation of handheld computer devices has either a single input device, or multiple input devices. However, the handheld devices with multiple input devices are generally comprised of diverse input devices. In other words, the input devices are separate and distinct, and are not used or programmed for use in a joined manner.

With the advancement of technology, computer apparatus have been decreasing in size, thereby making the computer apparatus more portable. However, the portability of the apparatus does not commonly accommodate input of data. Most portable apparatus are not accompanied with a full size QWERTY keyboard, as this would mitigate the benefits of the portability. Therefore, there is a need for the handheld apparatus to accommodate multiple input devices that are sized to be proportional with the apparatus. At the same time, the input devices should accommodate commands that may otherwise only be available in a desktop or a new command that is unique to the handheld portable apparatus.

### SUMMARY OF THE INVENTION

This invention comprises a device, method, and article of manufacture for controlling presentation of an image on a visual display with use of two or more input devices.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a block diagram of a handheld computing apparatus.

FIG. 2 is a block diagram of a top view of the chassis of the handheld computer apparatus of FIG. 1.

FIG. 3 is a block diagram of a top view of the handheld computing apparatus with a mapping of the input devices.

FIG. 4 is a chart showing the different commands that may be used with the input devices to communicate with an object represented on the visual display.

FIG. 5 is an image subject to zooming-in.

FIG. 6 is an image subject to zooming-out.

FIG. 7 is an image subject to moving to the left.

FIG. 8 is an image subject to rotation.

FIG. 9 is a chart showing the different commands that may be used with the input devices to communicate with an image of a three dimensional object represented on the visual display.

FIG. 10 is an illustration of a three dimensional image moved clockwise in the roll dimension.

FIG. 11 is an image subject to cropping

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of joystick, input devices, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Technical Details

The handheld computing apparatus is provided with two or more input devices. In one embodiment, the input devices are in the form of a joystick. However, the invention should not be limited to a joystick apparatus. In one embodiment, the input device is in the form of a track ball, a rocker pad, a touch pad, etc. For purposes of describing the invention, the description will reference a joystick input device. Furthermore, the examples below depict a handheld device with a built-in visual display. However, the invention is not limited to an apparatus with a built in visual display, as the visual display can be external to the device.

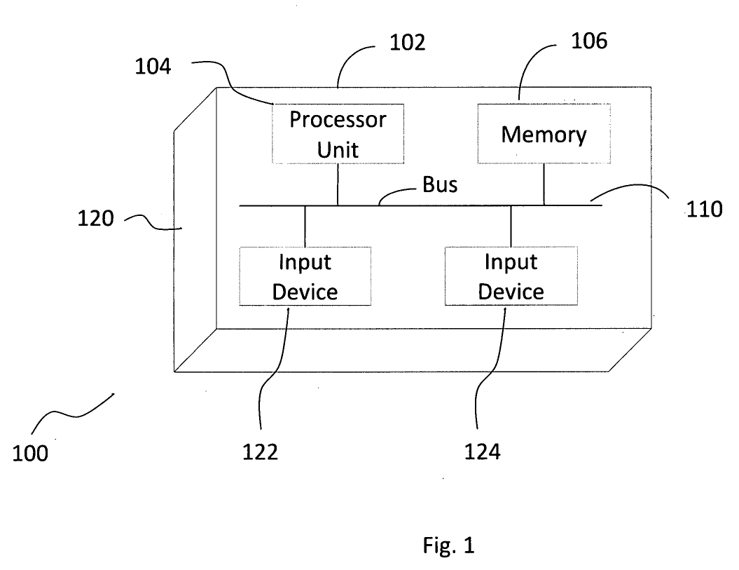

FIG. 1 is a block diagram (100) of a handheld computing apparatus (102). In general, the handheld computer apparatus (102) is provided with a processor unit (104) coupled to memory (106) by a bus structure (110). Although only one processor unit (104) is shown, in one embodiment, the apparatus (102) may include more processor units in an expanded design. As shown, the apparatus has a chassis (120) that serves as a casing to house the internal components of the apparatus. In addition, at least two input devices (122) and (124) are shown in communication with the processor unit (104). Accordingly, the handheld computing apparatus (102) is provided with a minimum of two input devices.

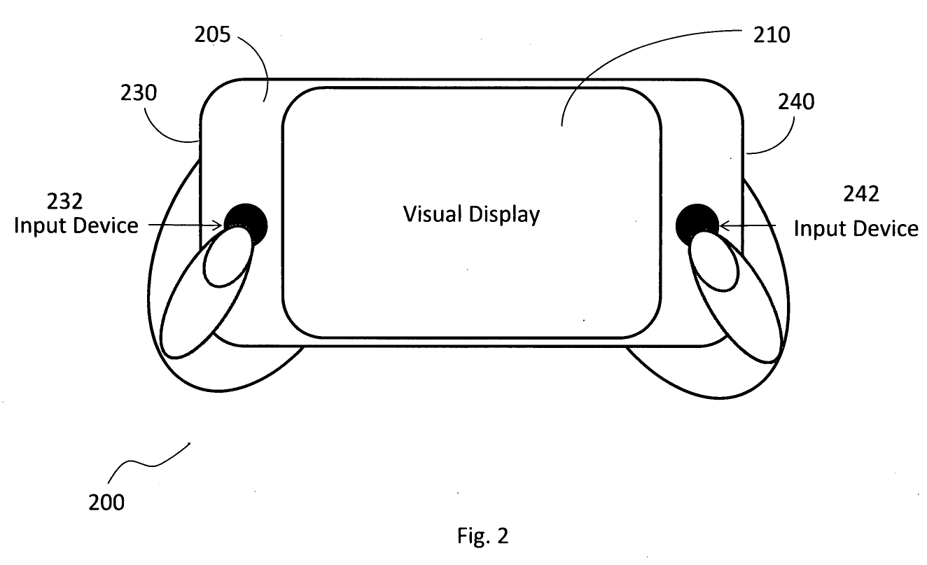

FIG. 2 is a block diagram (200) of a top view of the chassis of the handheld computer apparatus of FIG. 1. The top surface (205) of the chassis includes a visual display (210). On opposite sides (230) and (240) of the chassis are input devices (232) and (242). Each of the input devices (232) and (242) are in communication with the processor unit (104) housed in the chassis. The input devices (232) and (242) are tools that are employed to convey data to the processor unit (104) and to communicate with data presented on the visual display (210).

In one embodiment, each of the input devices (232) and (242) are of the same format. For example, the input devices may both be joysticks. The use of input devices that are of the same format makes it possible to use intuitive combination commands to control data presented on the visual display (210). Although the embodiments herein will be described with the use of joystick input devices, the same principles can be extended to other forms of input devices, selectors, and pointing devices. For example, the input devices are shown on opposite side of the visual display. However, they are not limited to this layout. In one embodiment, the input devices can be located on the top surface of the housing as well as on the sides or even on its back, and can be operated by thumbs or any other fingers.

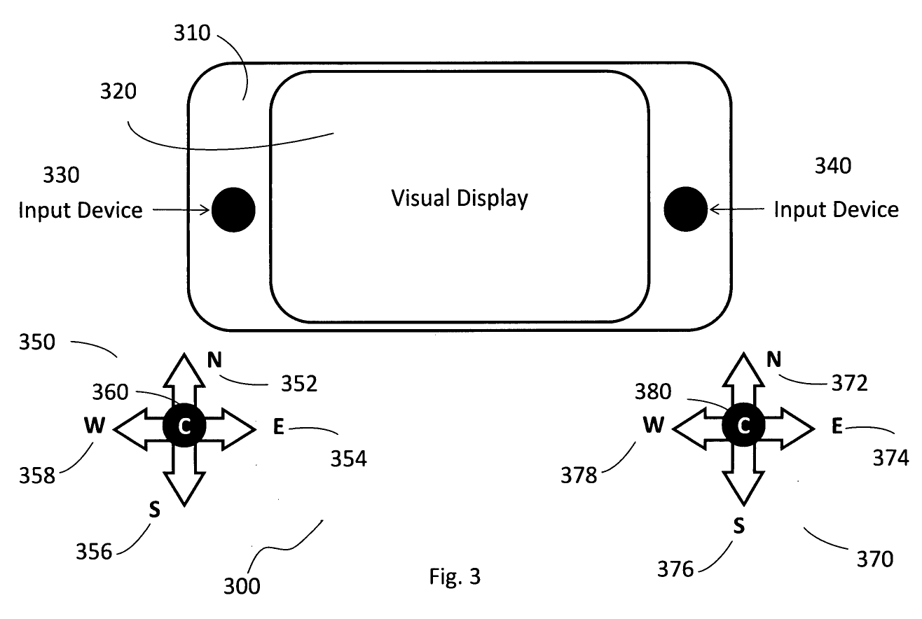

FIG. 3 is a block diagram (300) of a top view of the handheld computing apparatus with a mapping of the input devices. As shown, the top side of the chassis (310) is provided with a visual display (320) and input devices (330) and (340) on opposite sides of the visual display (320). A first mapping (350) is provided for the first input device (330). The mapping is a description of the different manipulations that may be provided to the input device in the form of a joystick apparatus. As shown, the mapping includes the directions of forward (352), right (354), backward (356), left (358) and center (360). Similarly, a second mapping (370) is provided for the second input device (340). As shown, the mapping includes the directions of forward (372), right (374), backward (376), left (378), and center (380). For both the first and second input devices (330) and (340), respectively, a sixth position is when the input device is not engaged. Although the joystick is shown with six degrees of positioning, the invention should not be limited to this quantity of degrees. In one embodiment, either the joystick or an alternative input device is provided with a fewer quantity or a larger quantity of degrees of positioning. Furthermore, the position indications of forward, right, backward, and left are not geographical limitations. These indications are coordinates employed to describe the position of the input device with respect to the top surface of the chassis of the handheld computing apparatus.

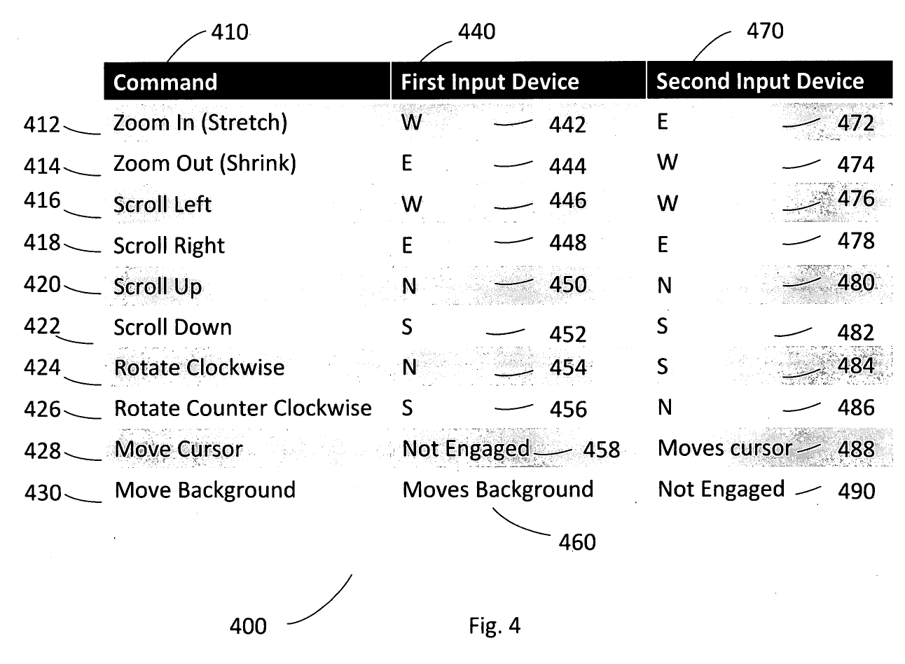

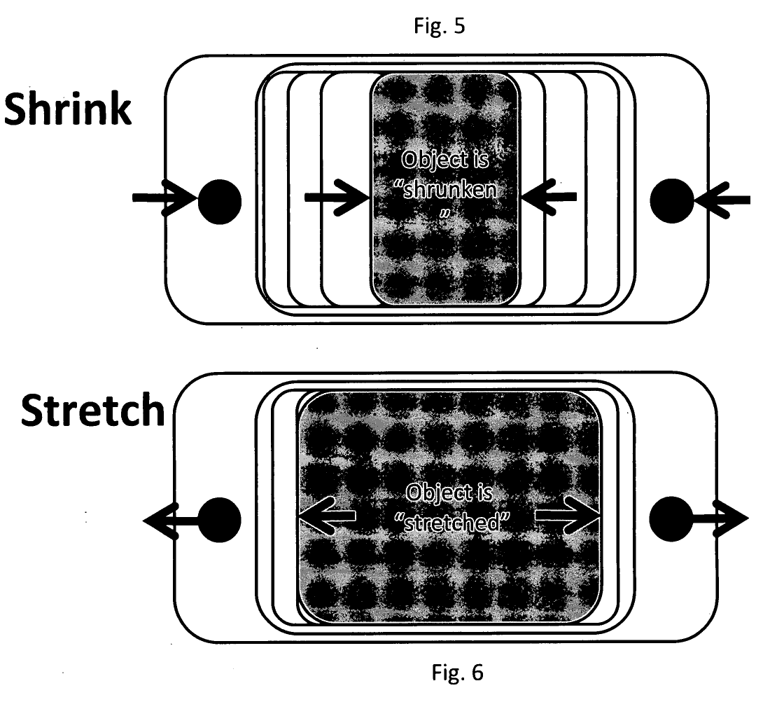

As noted above, the input devices may be used together to communicate with an image on the visual display. FIG. 4 is a chart (400) showing the different commands that may be used with the input devices to communicate with an object represented on the visual display. There are three columns in the chart (400). The first column (410) represents the input command requested to the image on the visual display. The second column (440) represents the position required by the first input device (232, 330) to satisfy the associated command. The third column (470) represents the position required by the second input device (242, 340) to satisfy the associated command. More specifically, and as shown in the chart (400), if it is desired to zoom into the image on the visual display in order to see more detail (412), the first input device must be moved in the direction of left (442), and the second input device must be moved in the direction of right (472). An example of an image subject to zooming-in is shown in detail in FIG. 5. To zoom out of the image on the visual display in order to see a less detailed view (414), the first input device must be moved in the direction of right (444), and the second input device must be move in the direction of left (474). An example of an image subject to zooming-out is shown in detail in FIG. 6. In other words, the joystick input devices must be moved in opposite directions for zooming into the image and zooming out of the image.

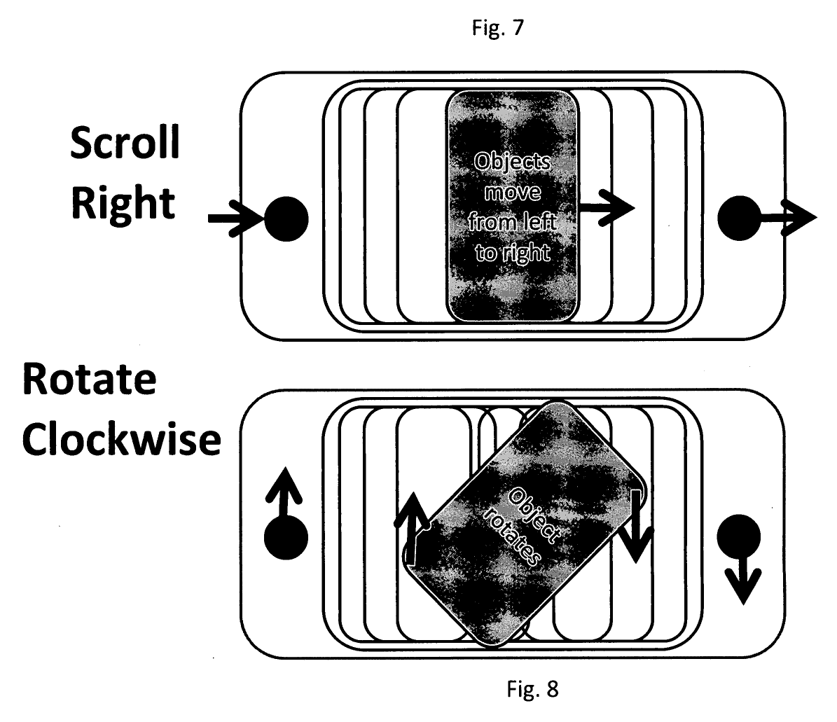

There are additional commands that may also be used to communicate with the image on the visual display. For example, it may be desirable to scroll the image to the left (416). This requires that the first input device must be moved in the direction of left (446), and the second input device must be moved in the direction of left (476). An example of an image subject to moving to the left is shown in detail in FIG. 7. Conversely, to scroll the image to the right (418), the first input device must be moved in the direction of right (448) and the second input device must be moved in the direction of right (478). As shown, to scroll the image in a particular direction, the input devices must both be moved in the same direction. Similarly, to scroll image up on the visual display (420), both the first and second input devices must be moved in the direction of forward (450) and (480), and to scroll the image down on the display (422), both the first and second input devices must be moved in the backward direction (452) and (482). In one embodiment, when there are multiple images displayed on the visual display, the same scrolling technique may be applied to scroll through each of the individual images. In addition to moving the image in the visual display, the image may also be rotated on the display. For example, the image may be rotated in a clockwise direction (424) by moving the first input device in the direction of forward (454) and moving the second input device in the backward direction (484). An example of an image subject to rotation is shown in detail in FIG. 8. The image may also be rotated in the counter clockwise direction (426) by moving the first input device in the backward direction (456) and the second input device in the direction of forward (486).

In addition to control of an image on the display, the input devices may also be employed to communicate with a cursor on the visual display in terms of movement of the cursor (428). As shown, to move the cursor, one of the input devices remains stationary (458), i.e. not engaged, while the second input device moves the cursor on the visual display (488). In a similar manner, the input devices may also communicate with the background on the visual display by moving the background (430). As shown, to move the background the first input device is engaged (460), and the second input device is not engaged (490). In the embodiments shown in (428) and (430), one of the input devices is shown engaged with the other not engaged. The invention should not be limited to the specific input device and mappings shown herein. For example, in one embodiment, the opposite mapping of the input devices may be employed.

The table (400) of FIG. 4 as described above shows commands employed to manipulate a visual two dimensional image represented on a visual display. As shown and described in FIG. 6, to stretch an object on the display, a user will have to actuate both input devices away from each other. Conversely, as shown and described in FIG. 5 to shrink an object on the display, a user will have to pull the input devices towards each other, as if compressing the physical object. To further illustrate the commands, FIG. 7 shows how both the input devices have to be actuated to move to the right in order to move an object on the visual display from a left position to a right position, and FIG. 8 shows how one input device must be actuated in an upward direction and a second input device in a downward direction in order to rotate the object on the visual display in a clockwise direction. The mappings shown herein are merely exemplary. It should be noted that the mappings of input device movements to commands are not limited to those shown herein. In one embodiment, the mappings may be modified to accommodate different movements of the input device(s).

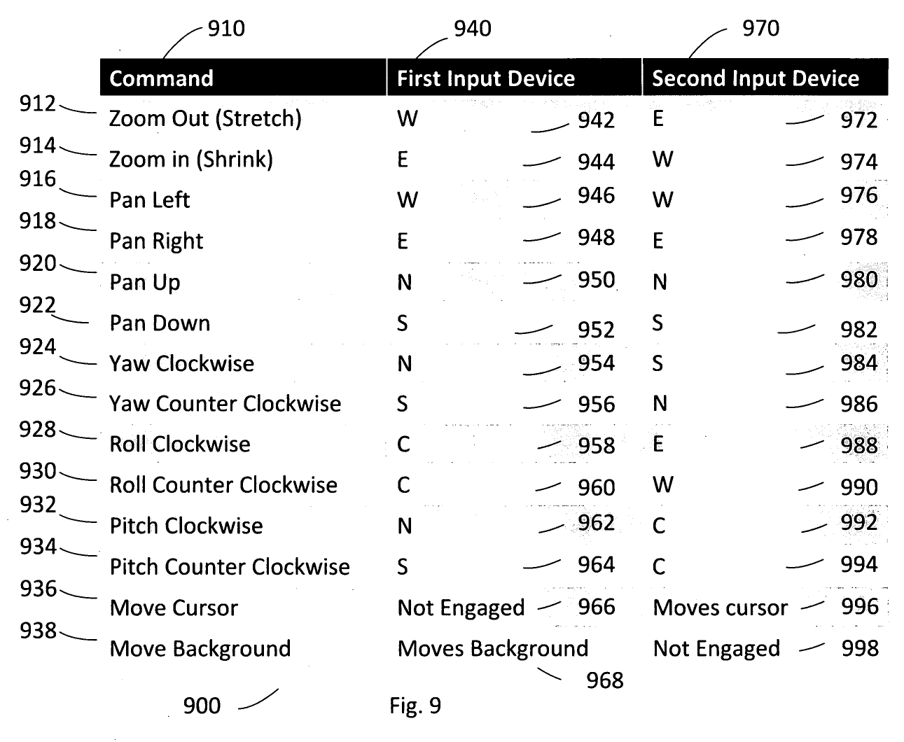

It is known in the art that images on a visual display are not limited to two dimensional images and may come in the form of three dimensional images. The input devices and associated movement thereof may be expanded to be mapped to the characteristics of a three dimensional image. In one embodiment, only two input devices may be required for manipulating the three dimensional image. FIG. 9 is a chart (900) showing the different commands that may be used with the input devices to communicate with an image of a three dimensional object represented on the visual display. There are three columns in the chart (900). The first column (910) represents the input command required to manipulate an image on the visual display. The second column (940) represents the position required by the first input device (330) to execute the associated command. The third column (970) represents the position required by the second input device (340) to execute the associated command. More specifically, and as shown in the chart (900), if it is desired to zoom into an image on the visual display in order to see more detail (912), the first input device must be moved in the direction of left (942), and the second input device must be moved in the direction of right (972). To zoom out of an image on the visual display in order to see a less detailed view of the image (914), the first input device must be moved in the direction of right (944), and the second input device must be move in the direction of left (974). In other words, the input devices must be moved in opposite directions for zooming into an image and zooming out of an image.

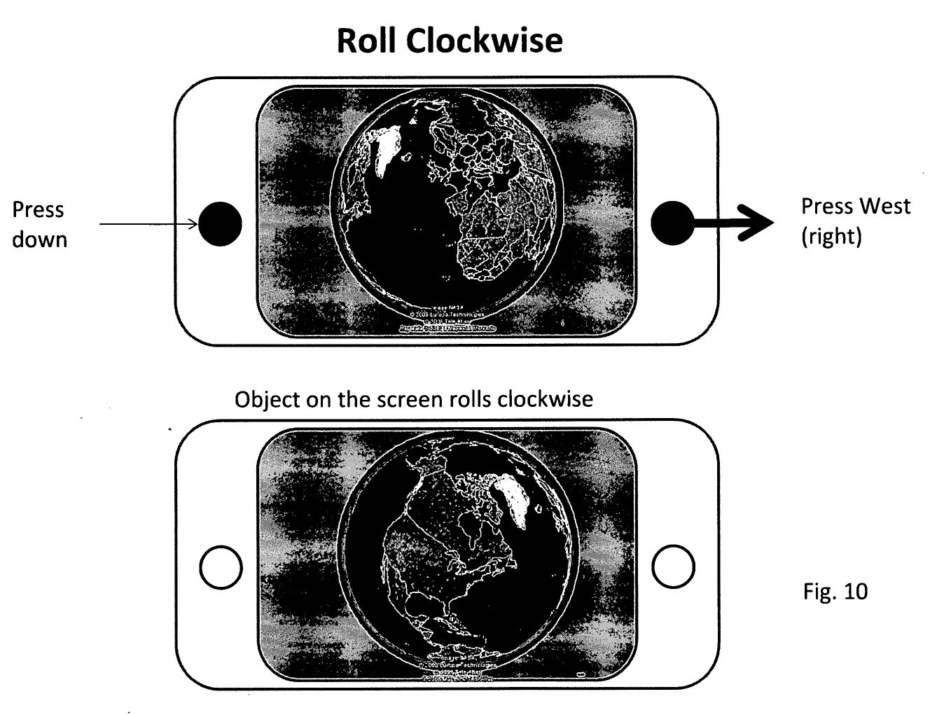

There are additional commands that may also be used to communicate with the image on the visual display. For example, it may be desirable to pan the image to the left (916). This requires that the first input device must be moved in the direction of left (946), and the second input device must be moved in the direction of left (976). Conversely, to pan the image to the right (918), the first input device must be moved in the direction of right (948) and the second input device must be moved in the direction of right (978). As shown, to pan the image in a particular direction, the input devices must both be moved in the same direction. Similarly, to pan the image up on the visual display (920), both the first and second input devices must be moved in the direction of forward (950) and (980), and to pan the image down on the display (922), both the first and second input devices must be moved in the backward direction (952) and (982). In addition to moving the image in the visual display, the image may also be rotated on at least three dimensions, including, roll, pitch, and yaw on the display. For example, the image may be rotated clockwise in the yaw dimension (924) by moving the first input device in the direction of forward (954) and moving the second input device in the backward direction (984). Conversely, the image may also be rotated counter clockwise in the yaw dimension (926) by moving the first input device in the backward direction (956) and the second input device in the direction of forward (986). As noted, a three dimensional image may be rotated equally in the roll, pitch, and yaw dimensions. To move the image clockwise in the roll dimension (928), the first input device is moved center (958) and the second input device is moved in the direction of right (988). Movement in the center direction is mapped to having the input device center pressed down into the chassis. In one embodiment, an alternative mapping may be provided for the center direction. FIG. 10 is an illustration of a three dimensional image moved clockwise in the roll dimension. To move the image counter-clockwise in the roll dimension (930), the first input device is again moved center (960) and the second input device is moved in the direction of left (990). Finally, to move the three dimensional image clockwise in the pitch dimension (932), the first input device is moved in the direction of forward (962) and the second input device is moved center (992). To move the three dimension image counter-clockwise in the pitch dimension (934), the first input device is moved in the backward direction (964) and the second input device is moved center (994). Accordingly, as shown herein, a mapping of two input devices accommodates movement of a three dimensional object on a visual display in the roll, pitch, and yaw directions.

In addition to control of an image on the display, the input devices may also be employed to communicate with a cursor on the visual display in terms of movement of the cursor. As shown, to move the cursor (936), one of the input devices remains non-engaged (966), while the second input device moves the cursor on the visual display (996). In a similar manner, the input devices may also communicate with the background on the visual display by moving the background (938). As shown, to move the background, the first input device is engaged (968) and the second input device is not engaged (998). In the embodiments shown in (936) and (938), one of the input devices is shown engaged with the other not engaged. The invention should not be limited to the specific input device and mappings shown herein. In one embodiment, the opposite mapping of the input devices may be employed.

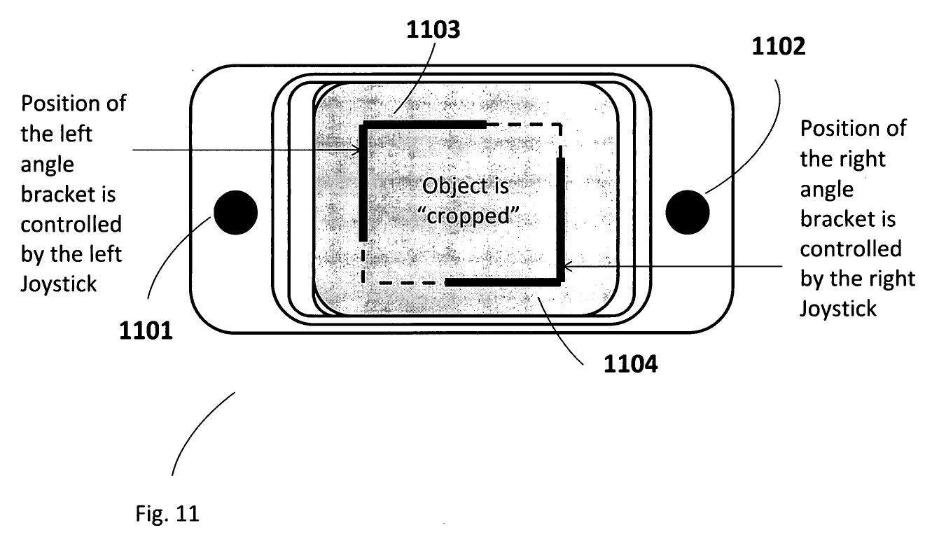

FIG. 11 is a top view (1100) of a handheld computing apparatus demonstrating how the input devices (1101) and (1102) can be used for image editing. In the example shown herein, an image editing application projects two angle brackets (1103) and (1104) on the image. Each of the angel brackets (1103) and (1104) can be independently controlled by one of the input devices, e.g. input device (1101) can control (1103) bracket and input device (1102) can control (1104) bracket. Thus the brackets can be positioned anywhere on the image and a simultaneous actuation of input devices (1101) and (1102) can be used as a command to crop out a desired part of the image.

As shown both with respect to communication with a two dimensional image and a three dimensional image, the input devices must each be moved in directions specified by the mappings. In each case, the input devices must each be moved in a direction that meets or exceeds a threshold so that the movement is recognized by the processor.

Embodiments within the scope of the present invention also include articles of manufacture comprising program storage means having encoded therein program code to communicate data between the input device and data presented on the visual display. Such program storage means can be any available media which can be accessed by a general purpose or special purpose computer. By way of example, and not limitation, such program storage means can include RAM, ROM, EPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or propagation medium. Examples of a computer-readable medium include but are not limited to a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

It will be appreciated that, although specific embodiments of the invention have been described herein for purposes of illustration, various modifications may be made without departing from the spirit and scope of the invention. In particular, the input devices may come in different forms, including a proportional input device, such as a joystick, a rocker pad, a touch pad, a track balls, and alternative input devices. Additionally, the invention should not be limited to the mappings of the input devices to the described movement and communication with the image on the visual display. In one embodiment, there may be different mappings of the input devices to the image, or even additional mappings for different image movements. Furthermore, the invention should not be limited to a fixed set of mappings. In one embodiment, an interface may be provided to modify the mappings of the input devices. Accordingly, the scope of protection of this invention is limited only by the following claims and their equivalents.

We claim:

1. A handheld computing device comprising:
a processor in communication with memory;
a visual display in communication with the processor to show images thereon;
at least two input devices in communication with the processor;
a mapping of position of the input devices to the image such that a substantially simultaneous movement of the input devices in excess of a set threshold changes movement of the image on the display.

2. The device of claim 1, wherein the input device is selected from the group consisting of: joysticks, rocker pads, touch pads, and track balls.

3. The device of claim 1, wherein the image is a two dimensional image.

4. The device of claim 1, wherein the image is a three dimensional image.

5. The device of claim 4, wherein the mapping accommodates movement in the roll, pitch, and yaw directions.

6. The device of claim 1, further comprising software in communication with the processor and memory to interpret movement of the input devices and to reflect the interpretation on the visual display.

7. The device of claim 1, wherein the visual display is located in a position relative to a chassis of a computing apparatus, the position selected from the group consisting of: internal to the chassis, and external from the chassis.
